(19) United States
(12) Patent Application Publication
(10) Pub. No.: US 2007/0035182 A1
(43) Pub. Date: Feb. 15, 2007

(54) Device for detecting side impacts and pressure sensor

(76) Inventors: Matthias Wellhoefer, Stuttgart (DE); Volker Frese, Schwieberdingen (DE)

Correspondence Address: KENYON & KENYON LLP, ONE BROADWAY, NEW YORK, NY, 10004, US

(21) Appl. No.: 10/564,225

(22) PCT Filed: Jul. 8, 2004
(86) PCT No.: PCT/DE04/01477

§ 371 Date: May 23, 2006

(30) Foreign Application Priority Data
Jul. 15, 2003 (DE) 103 31 964.6

(51) Int. Cl. H01H 35/14

(52) U.S. Cl. 307/120

(57) ABSTRACT

A device for the detection of side impact and a pressure sensor, a mechanical switch being assigned to the pressure sensor as a plausibility sensor. This mechanical sensor is preferably situated in the housing of the pressure sensor.

### BACKGROUND INFORMATION

A device for detecting side impacts in a vehicle is described in German Patent No. DE 101 44 266. In this context, the side impact is detected using a pressure sensor which is situated in a side part of a vehicle. When there is a side impact, this pressure sensor reacts to an adiabatic pressure increase created by the side impact. A plausibility sensor is indispensable for the sensing of the side impact. For this, either an acceleration sensor is provided, for example, in the B column or a loudspeaker that is located in the side part itself.

### SUMMARY OF THE INVENTION

The device according to the present invention for detecting side impacts and the pressure sensor according to the present invention have the advantage, compared to this, that the plausibility sensor is at this point configured as a switch, which is assigned to the housing of the pressure sensor. This means that the switch is located at least in the vicinity of the housing in the side part of the vehicle. A switch as plausibility sensor has the advantage that it specifies its state as the plausibility signal, that is, whether it is open or not. This corresponds to an information content of only one bit. Thereby, for example, compared to an acceleration sensor, it saves considerably on transmission bandwidth. Furthermore, a switch is a very reliable sensing element, which may be manufactured in a cost-effective manner. Then, too, the switch may be flexibly situated, depending on the requirements and the existing situation.

It is especially advantageous that the switch is situated directly in the housing of the pressure sensor. Because of this, the pressure sensor and the plausibility sensor are in fact situated in one unit, and may thus be accommodated in the vehicle in a manner saving space and wiring.

The switch may be designed in various ways: a) a Hamlin switch, b) a micromechanical acceleration switch, c) a piezoelectric acceleration switch.

It is also of advantage if the switch is a so-called Hamlin switch which works extremely reliably, and which has already found wide distribution as a plausibility sensor in air bag electronics.

A Hamlin switch is made up of a permanent magnet ring that has been applied to a (plastic) mechanism. On the inside of the mechanism there is a switch made up of 2 metal contacts. The permanent magnet is movable on the mechanism, and is held at the edge of the mechanism by a spring that is also on the mechanism. In response to an acceleration, the permanent magnet is moved on the mechanism, pushed over the contact and closes the latter magnetically for the duration of the effective acceleration, which holds the magnet over the contact against the force of the spring. The magnet is returned again to the stable initial position by the spring, if the acceleration is no longer acting upon the magnet, i.e. the switch is open again.

Besides a Hamlin switch, other mechanical switches are also possible. Furthermore, it is of advantage if the switch is connected directly to the ignition output stage in such a way that the switch releases the ignition output stage as a function of its state. This, too, simplifies the processing of the plausibility signal, since, in this instance, the ignition output stage is directly activated without the processor, for example, having to process the plausibility signal in the air bag control unit that is situated centrally in the motor tunnel. However, it is possible alternatively that the processor itself evaluates this plausibility signal which, as shown above, is made up of only one bit. This bit, then, represents a flag. The processor then activates the ignition output stage as a function of this signal.

What is of advantage, is that the switch position (1 bit) is coded along with the pressure signal, and consequently, additional lines for the switch to the control unit may be saved.

Finally, it is also advantageous that the switch is situated in such a way that it directly interrupts, as a function of its state, the data transmission from the pressure sensor to the processor, for instance that, in the air bag control unit or another control unit, it interrupts as a function of its state. Only when the switch indicates that there has been an impact, in which it is closed, for example, the switch is then closed and the data from the pressure sensor may be transmitted to the air bag control unit for processing. This too saves computational capacity in the air bag control unit and is a simple way of utilizing it as a plausibility signal.

It is possible that more than one plausibility sensor is used, in order to establish the plausibility of the signal of a pressure sensor. For instance, besides the switch, an acceleration sensor may also be used in order to generate a plausibility signal in response to various crash types. It is also possible that more than one mechanical switch is assigned to a pressure sensor.

### BRIEF DESCRIPTION OF THE DRAWINGS

FIG. 1 shows a first block diagram of the device according to the present invention.

FIG. 2 shows a second block diagram of the device according to the present invention.

FIG. 3 shows a third block diagram of the device according to the present invention.

FIG. 4 shows a fourth block diagram of the device according to the present invention.

### DETAILED DESCRIPTION

A pressure sensor situated in the side part of a vehicle is increasingly being used for sensing a side impact. However, what is decisive for the performance of the pressure sensor, which is itself very rapid, is also the performance of the assigned plausibility sensor, for, without a plausibility sensor, the use of a crash sensor is not possible if one wishes to obtain certainty concerning the transmitted signals of the crash sensor. Acceleration sensors are slow compared to a pressure sensor. As a result, it is provided, according to the present invention, that as a plausibility sensor one should use a switch that is directly assigned to the housing of the pressure sensor. The assignment may be implemented by building the switch into the housing of the pressure sensor, or by adhering it onto the housing or by other fastening to the housing of the pressure sensor or by providing that the switch be mounted in the immediate vicinity of the pressure sensor housing. The switch supplies a signal that is simple to evaluate, i.e. is it closed or not, and consequently saves enormously on bandwidth. Besides that, this plausibility sensor is a robust and very rapid sensor.

FIG. 1 explains the device according to the present invention in a block diagram. A pressure sensor 10, a mechanical switch 11 and an acceleration sensor 15 are respectively connected to data inputs of a control unit 12 for means of restraint. These means of restraint include air bags, belt tensioners, rollover brackets, etc. At a fourth data input of control unit 12, an additional sensor system 13 is connected, which includes additional crash sensors, accident sensors, passenger compartment sensors and precrash sensors. Air bag control unit 12 is connected to means of restraint 14 via a data input. The signals of pressure sensor 10, in this instance, as an example, only one sensor is shown, are shown to be plausible by the signal of mechanical switch 11 or acceleration sensor 15. The signal of switch 11 is very rapid, and will therefore hardly impair the signals of pressure sensor 10 with respect to detection time of the impact, while the signals of acceleration sensor 15 arrive considerably later compared to the signals of pressure sensor 10, and therefore impair the performance of pressure sensor 10. However, in certain types of crashes using an additional acceleration sensor 15 may be necessary for confirming plausibility, such as in crashes that do not directly involve a side impact but, for example, an offset crash. Control unit 12 activates the means of restraint as a function of the signals of sensors 10, 11, 13 and 15, the appropriate means of restraint being selected by the passenger compartment sensor system; during this selection, the seriousness of the crash also coming into effect. If a very light impact is involved, belt tensioners are sufficient, but if there is a heavy crash, air bags should be used in any case, inasmuch as the respective person to be protected makes it possible. If a very light person is involved, use of air bags is not indicated.

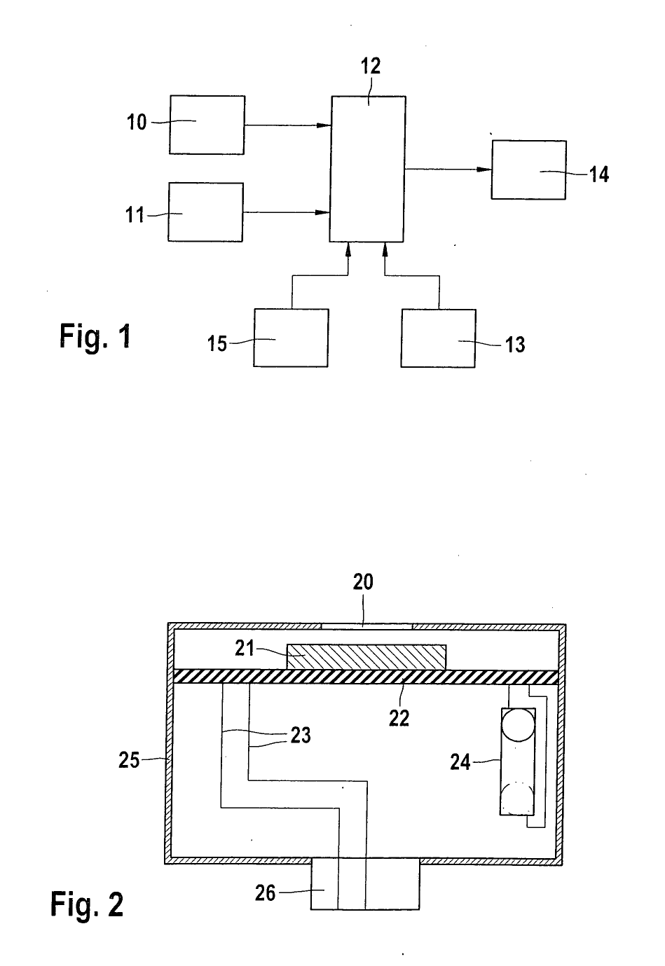

FIG. 2 shows the pressure sensor according to the present invention in a block diagram. The housing of pressure sensor 25 has a pressure inlet opening 20. This is utilized by a sensor element 21 to measure the pressure in a side part of the vehicle. Evaluation electronics 22 amplifies, filters and digitizes the signals of sensor element 21, which here is a diaphragm. These signals are then transmitted via lines 23 and interface 26 to a control unit. In the case of the pressure sensor, only a unidirectional transmission to the control unit is necessary here, so that, then, for example, a current interface may be used in which a no-signal current is modulated by the pressure sensor and especially interface 26. Another switch 24 is connected to electronic system 22, which closes as a function of a mechanical impact. If this impact is so potent that a crash may be involved, switch 24 will close, and this signal is passed on by electronic system 22 via line 23 and interface 26 to the air bag control unit. In this context, this signal may be supplied directly to the air bag control unit and thus to the processor, or directly to the ignition output stage, in order to release the latter in the case of a crash. The final release of the crash stage may also be influenced by additional signals. The signal of mechanical switch 24 may also be used to interrupt the data transmission of the pressure sensor to the control unit if switch 24 is open, and thus indicates no impact. In this context, mechanical switch 24 is configured in such a way that it remains closed during a crash for only a certain time, and then jumps back again automatically into the open position. This requires the presence of a spring force or other techniques which are implemented, for example, in a Hamlin switch.

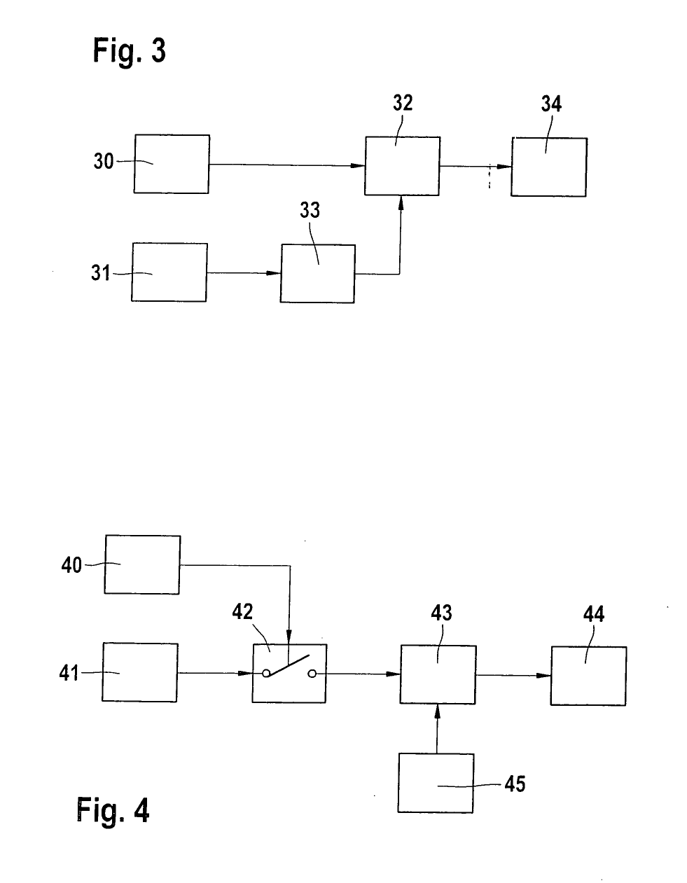

FIG. 3 shows the device according to the present invention in a block diagram. In this instance, mechanical switch 30 is connected directly to ignition output stage 32, to which means of restraint 34 are connected. However, pressure sensor 31 supplies its signals to a processor 33, which is, for example, situated in the air bag control unit, which then triggers ignition output stage 32. The triggering takes place, for example, using the so-called SPI (serial peripheral interface) bus by appropriate ignition commands.

FIG. 4 shows an additional block diagram of the device according to the present invention. Pressure sensor 41 is connected to a switch 42. This switch 42 is closed by switch 40, which acts as a plausibility sensor. This closing takes place only when switch 40 detects an impact. Then the data of pressure sensor 41 may be transmitted to air bag control unit 43, so that the latter evaluates the signals of pressure sensor 41. As a function of this and additional sensor signals from a sensor system 45, control unit 43 activates means of restraint 44.

1-8. (canceled)

9. A device for a detection of a side impact to a vehicle, comprising:
a pressure sensor situated in a side part of the vehicle, the pressure sensor having a housing; and
a plausibility sensor, the plausibility sensor being a switch that is assigned to the housing of the pressure sensor.

10. The device according to claim 9, wherein the switch is situated in the housing.

11. The device according to claim 9, wherein the switch is a Hamlin switch.

12. The device according to claim 9, wherein the switch is connected directly to an ignition output stage in such a way that the switch releases the ignition output stage as a function of its state.

13. The device according to claim 9, further comprising a processor for releasing an ignition output stage as a function of a signal of the switch.

14. The device according to claim 13, wherein the switch is situated in such a way that the switch interrupts a data transmission from the pressure sensor to the processor, as a function of its state.

15. The device according to claim 9, wherein the signal of the switch is coded directly with a pressure signal.

16. A pressure sensor for a detection of a side impact to a vehicle, comprising:
a housing; and
a switch situated in the housing.
